(19) United States
(12) Patent Application Publication
(10) Pub. No.: US 2019/0319313 A1
(43) Pub. Date: Oct. 17, 2019

(54) BATTERY ENCLOSURE FOR INCORPORATING AN ELECTRONIC BATTERY PERFORMANCE ENHANCEMENT DEVICE

(71) Applicant: CANADUS POWER SYSTEMS, LLC, Twinsburg, OH (US)

(72) Inventors: Jack A. SCOTT, Rockwall, TX (US); Daniel C. BIGGS, Jr., Reminderville, OH (US)

(21) Appl. No.: 16/387,031

(22) Filed: Apr. 17, 2019

Related U.S. Application Data
(60) Provisional application No. 62/658,902, filed on Apr. 17, 2018.

(51) Int. Cl. H01M 10/42; H01M 2/06; H01M 10/48; H01M 2/10

(52) U.S. Cl. CPC H01M 10/4257; H01M 2/06; H01M 2010/4271; H01M 2/1094; H01M 10/488

(57) ABSTRACT

A battery enclosure including a battery case for enclosing at least one cell in contact with an electrolyte; a positive post and a negative post connected to the at least one cell and protruding from the case; the case having a recess shaped to receive an electronic battery performance enhancement device (EBPED); and a cover that covers the recess and the EBPED when received in the recess such that the EBPED, including positive and negative leads of the EBPED when connected to the positive post and the negative post, are beneath the cover.

### TECHNICAL FIELD

The present disclosure relates to systems for enhancing battery performance and/or monitoring batteries, and more particularly, to systems in which an electronic battery performance enhancement device and/or monitor is incorporated into a battery enclosure.

### BACKGROUND

Rechargeable battery systems use many different combinations of electrode materials and electrolytes, including among them lead-acid, nickel-cadmium, and lithium-ion. For applications that require relatively high surge currents, such as for powering starters for motor vehicles, a lead acid battery is frequently used. Lead-acid batteries generally consist of a plastic or steel-backed plastic case containing one or more electrolytic cells. Each cell is made up of two plates: one made from sponge lead (Pb), and the other from a paste of litharge (PbO), red lead (Pb₃O₄), lead sulfate (PbSO₄), and sulfuric acid (H₂SO₄) mixed with certain proprietary binders and expanders.

During the forming process, most of these ingredients are converted to a coating of lead dioxide (PbO₂) on tiny strands or particles of metallic lead. The sponge lead metal forms the negative terminal of the battery, and the lead dioxide paste forms the positive terminal. The cells are filled with diluted sulfuric acid (H₂SO₄) having a range of specific gravities depending on the particular battery application. Typical starting-lighting-ignition (SLI) batteries, for example, contain sulfuric acid at a specific gravity of between 1.275 and 1.285. Batteries contain one or more two-volt cells connected in series. A 12-volt battery, for example, consists of six cells connected in series.

There are many types of lead-acid batteries, characterized by their engineering design, application, size, and voltage. Different battery engineering designs include, but are not limited to, flooded cell, absorbent glass mat (AGM), spiral wound, maintenance-free, and gel. Applications include SLI and motive power/traction deep cycle (DC) batteries, and anything in between, which may have characteristics of both. Two-volt mining helmet DC batteries might weigh just a few pounds, a car starting battery (i.e., an SLI battery) could weigh 24 pounds, and a 250-volt underground coal-hauler DC battery might weigh 20,000 pounds or more.

As lead-acid batteries are “cycled” through numerous charge and discharge sequences, particularly if the batteries are not charged fully, or are allowed to remain in a partially discharged state for extended periods, micro-crystalline lead sulfate is converted over time, through a chemical phenomenon called Ostwald ripening, to a very stable, large crystalline form that severely impedes the chemical reaction between the sulfuric acid and the plates of the battery cell from occurring. This process, called “sulfation,” is the primary cause of declining performance in a lead-acid battery over time, and is ultimately the leading root cause of battery failure in lead-acid batteries. Sulfation cannot successfully be removed from the surface of the battery plates through conventional charging equipment.

Electronic battery performance enhancement devices, or EBPEDs, are electronic devices that enhance the performance and extend the life of rechargeable batteries, and include the Canadus battery desulfator (CBD), such as the Canadus HD-1224 desulfator/reconditioner manufactured by Canadus Power Systems, LLC of Twinsburg, Ohio, which is used for desulfating lead-acid batteries. The CBD keeps the plates of the battery cells free of large crystals of damaging lead sulfate. CBDs can be used for both SLI and motive power/traction DC batteries. CBDs draw a small amount of energy from a charger, an alternator, or from the battery itself, and convert it to high frequency, high energy (high voltage and high current) pulses that specifically target and remove the sulfation crystals as they form. In cases where batteries are already heavily sulfated, CBDs can arrest further sulfation and potentially remove some or most of it. In instances where sulfation has caused physical damage, such as cell shorting, grid corrosion, or grid breakage, CBDs may have little or no impact on improving battery capacity.

An EBPED comprises a printed circuit board with two or more wires affixed to it and may be encapsulated in epoxy or over-molded in plastic. The wires typically have ring or horseshoe terminal ends that are attached to the positive and negative lead posts of a battery using the bolts located on the battery terminal clamps. An EBPED body can be affixed externally to the battery case with Velcro, an adhesive such as silicone, wire ties, brackets, or other methods.

Over time, an EBPED mounted on a battery is exposed to a variety of environmental conditions, including extreme heat, cold, moisture, vibration, salt, and particulate dirt and mud. Because an EBPED is exposed to harsh environmental conditions, and is visible, numerous events can cause its premature mechanical failure, unauthorized disconnection and removal, or theft—any of which would prevent the benefits to the associated battery of continued operation of the EBPED.

Also, because some forms of EBPEDs generate high-frequency electrical pulses as part of their process of desulfation, there is a risk that the EBPED may generate significant electromagnetic interference (EMI), which may take the form of radio-frequency noise or interference (RFI) emitted from the lead wires of the EBPED. RFI has the potential to interfere with AM radio reception and onboard electronics. The longer the lead wires, the worse the RFI, and shielding the RFI from an externally mounted EBPED is difficult and costly.

Another disadvantage of mounting an EBPED on the exterior of a battery is that an externally mounted EBPED requires an extra installation step in both original equipment manufacturer (OEM) and after-market applications. Accordingly, there is a need for a battery desulfation system that overcomes the foregoing disadvantages.

### SUMMARY

The disclosed battery performance enhancement system involves encasing the EBPED within the battery enclosure itself. The system provides the following advantages: it eliminates premature EBPED failure or loss events, it shields the EBPED leads, thereby significantly reducing or eliminating EMI from the EBPED leads, and it makes possible the manufacture of a premium performance battery with an embedded EBPED in a single enclosure. In one embodiment, the disclosed system includes a battery enclosure having a battery case for enclosing at least one cell in contact with electrolyte; a positive post and a negative post connected to the at least one cell and protruding from the case; the case having a recess shaped to receive a battery EBPED; and a cover that covers the recess and the EBPED when received in the recess such that the EBPED, including positive and negative leads of the EBPED when connected to the positive post and the negative post, are beneath the cover.

In another embodiment, a battery enclosure includes a battery case for enclosing at least one cell in contact with electrolyte; a positive post and a negative post connected to the at least one cell and protruding from the case; an EBPED connected to the positive post and the negative post; the case having a recess that receives the EBPED; and a cover that covers the recess and the EBPED.

Other objects and advantages of the disclosed battery enclosure for incorporating an EBPED will be apparent from the following description, the accompanying drawings, and the appended claims.

### BRIEF DESCRIPTION OF THE DRAWINGS

FIG. 1 is an exploded, front perspective view of an embodiment of the disclosed battery enclosure for incorporating a EBPED;

FIG. 2 is an exploded, front perspective view of another embodiment of the disclosed battery enclosure for incorporating a EBPED;

FIG. 3 is an exploded, side perspective view of the battery enclosure of FIG. 1;

FIG. 4 is an exploded side perspective view of the battery enclosure of FIG. 2.

FIG. 5 is an assembled, front perspective view of the battery enclosure of FIG. 1;

FIG. 6 is a bottom plan view of the battery compartment cover of the battery enclosure of FIG. 1;

FIG. 7 is a schematic side elevational view of the battery enclosure of FIG. 1, cutaway to show the interior of the battery case; and

FIG. 8 is a schematic side elevational view of a four-battery group incorporating the battery enclosure of FIG. 1.

### DETAILED DESCRIPTION

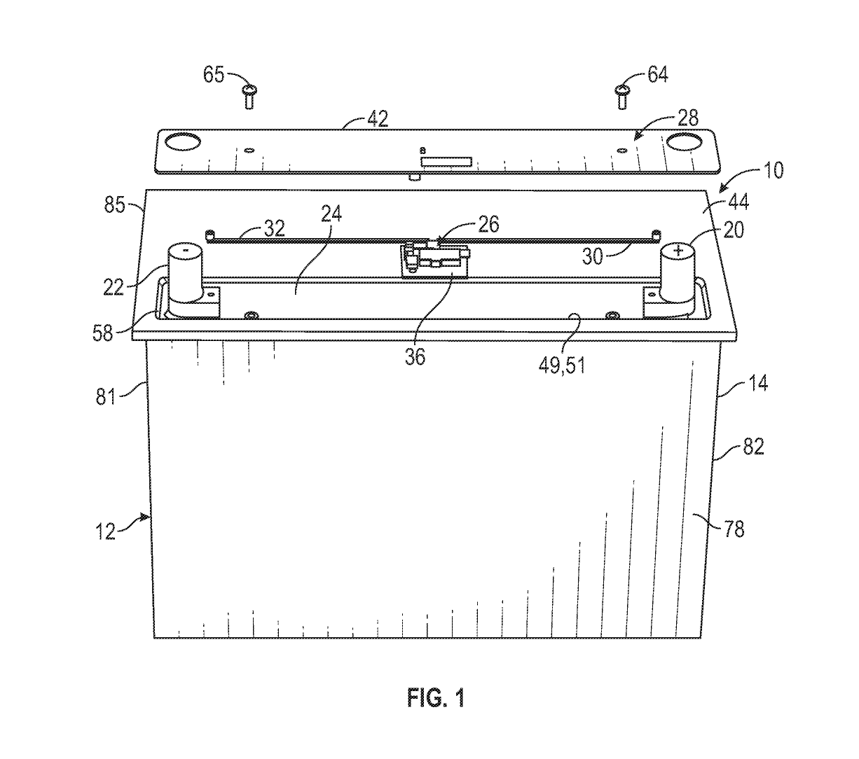

As shown in FIGS. 1, 3, and 7, the disclosed battery enclosure, generally designated 10, is incorporated in a battery, which in embodiments may take the form of a lead-acid battery 12. The lead-acid battery 12 may be any type of lead-acid battery, including absorbed glass mat (AGM), gelled electrolyte, and all forms of maintenance free, sealed, and valve regulated lead-acid (VRLA) batteries. The battery enclosure 10 includes a battery case 14 that encloses at least one cell 16 immersed in electrolyte 18. The battery case 14 includes a positive terminal or post 20 and a negative terminal or post 22 connected to the at least one cell 16 and protruding from the case 14.

The battery case 14 has a recess 24 shaped to receive, and in embodiments enclose entirely within, an EBPED 26, which in embodiments may take the form of a desulfator, and includes a cover 28 that covers the recess and in embodiments completely encloses the EBPED when received in the recess. The EBPED 26, including positive and negative leads 30, 32, respectively, of the EBPED, when connected to the positive post 20 and the negative post 22, are entirely beneath the cover 28. In exemplary embodiments, the EBPED 26 is constructed as disclosed in U.S. Pat. Nos. 5,677,612 and/or 5,648,714, the entire disclosures of which are incorporated herein by reference. In yet other embodiments, the EBPED 26 is a desulfator such as the Canadus Battery Desulfator Model HD-1224, manufactured by Canadus Power Systems, LLC of Twinsburg, Ohio.

In other embodiments, the recess 24 also sized and shaped to incorporate, and in embodiments enclose entirely within the recess, other independent devices. In embodiments, the EBPED takes the form of one or more types of informational and/or diagnostic equipment 26, such as a battery voltage sensor, a battery charge level sensor, a battery state of health sensor, and an alternator state of health sensor. In other embodiments, the component may take the form of an interface and/or control device 26, such as a low-voltage disconnect, a remote sensor for voltage monitoring and control, a battery charge booster for jump starts, and/or other devices and equipment usable to provide information, diagnose any part of the associated electrical system, or control any part of the electrical system. In embodiments, one or more of the foregoing components are incorporated into an EBPED, placed in the recess 24 instead of the EBPED, or placed in the recess as a discrete component in addition to the EBPED. Further, the disclosed battery enclosure 10 can be used with other battery chemistries, such as nickel-cadmium systems, whereby pulsation from the EBPED 26 could be used to improve battery chemistry, and not necessarily reduce sulfation.

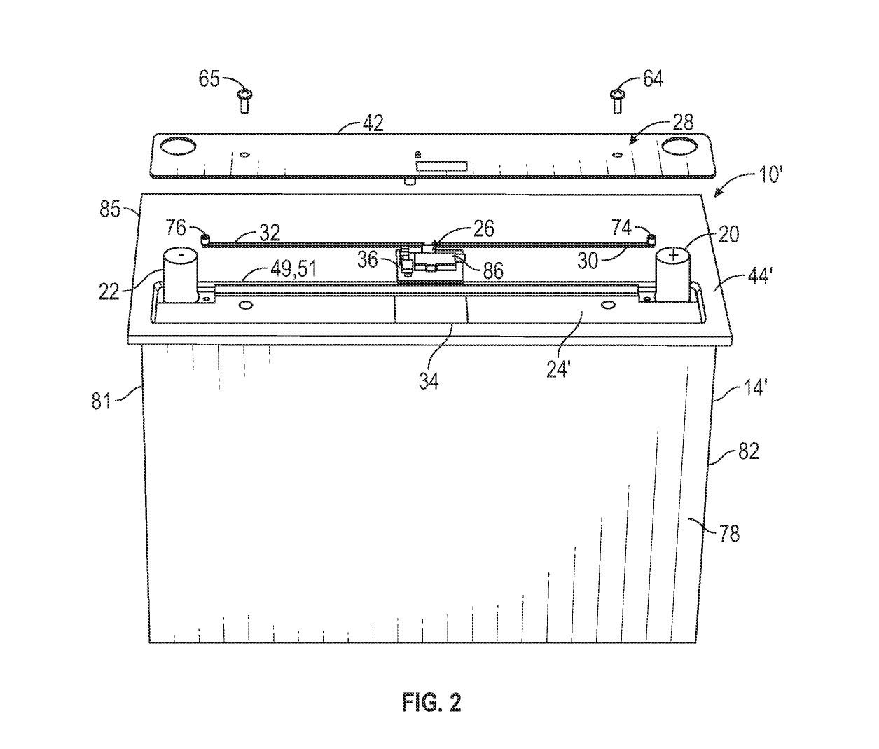

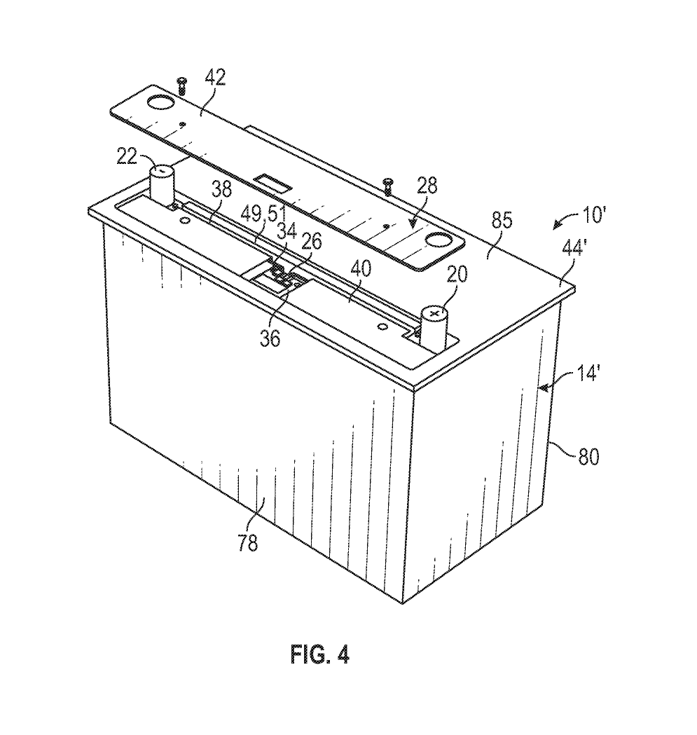

In an exemplary embodiment 10′ shown in FIGS. 2 and 4, a battery case 14′ includes a recess 24′ with an EBPED compartment 34 shaped to receive a EBPED body 36, a first channel 38, narrower than the EBPED compartment, extending between the EBPED compartment and the negative post that receives a negative lead from the EBPED therein; and a second channel 40, narrower than the EBPED compartment, extending between the EBPED compartment and the positive post 20 that receives a positive lead from the EBPED therein. In the embodiment shown, the first and second channels 38, 40 may together form a single, continuous channel that intersects the EBPED compartment 34. The EBPED compartment 34, the first channel 38, and the second channel 40 are covered by the cover 28.

In the embodiments 10, 10′ of FIGS. 1 and 3, and 2 and 4, respectively, the recess 24, 24′ is shaped such that an outer surface 42 of the cover 28 is flush with an outer surface 44 of the battery case 14, 14′ when attached to the battery case. In an exemplary embodiment, the battery cover 28 is made of, or includes, electromagnetic shielding that reduces or eliminates transmission of EMI and/or RFI from operation of the EBPED 26 through the cover 28 when the EBPED is received in the recess 24, 24′. As shown in FIG. 4, the cover 28 includes a plate 46, and the electromagnetic shielding is a layer of conductive shielding 48 on the plate. The layer of conductive shielding 48 may be applied to the outer surface 42, or in embodiments, to the inner surface 50 of the plate 46. In embodiments, the surface of the recess 24, 24′ also is formed of, or is coated or plated with, a material 49 that provides electromagnetic shielding that reduces or eliminates the transmission of EMI and/or RFI through the battery case 14, 14′, from operation of the EBPED 26.

In exemplary embodiments, the layer of conductive shielding 48 and/or the material 49 is a spray coating or plating or vacuum metalizing of conductive material on the inner surface 50 of the plate 46 facing the recess 24, 24′, and on the entire inner surface 51 of the recess, respectively. In an embodiment, the conductive material is selected from a copper conductive paint and a silver conductive paint. In an exemplary embodiment, silver conductive paint is used because of its relative resistance to corrosive environments. In other embodiments, the conductive paint is a graphite paint. Any conductive paint or conductive coating that provides adequate EMI/RFI shielding, and that may be applied to plastic or hard rubber, may be employed. In embodiments, the conductive material is applied to a dry film thickness that ranges from 0.001 in. (0.025 mm) to 0.002 in. (0.050 mm). In still other embodiments, the conductive shielding 48 is a layer of metal foil attached to the surface 50 and to the entire inner surface 51, for example by a suitable adhesive.

The plate 46 may be made of material selected from molded plastic and hard rubber, as is the battery case 14, 14′. In an exemplary embodiment, the layer of conductive shielding 48 and material 49 are grounded to the negative post 22 of the battery 12, 12′. This is accomplished by sizing the hole 52 such that the conductive shielding, which in embodiments is conductive paint, conductive electroplate, or conductive foil, contacts the negative post 22 when the cover 28 is mounted on the upper surface 44, 44′ of the battery 12, 12′, and providing an uncoated area 54 that surrounds the hole 56 for the positive post 20, so that the cover does not contact any part of the positive post. The contact between the plate 46 and the surface 51 of the recess 24, 24′, such as at the lip 58 or elsewhere, provides a current path from the surface 51 to the negative post 22 to ground the material 49 of the recess 24, 24′. The layer of conductive shielding 48 covers the entire underside of the cover 28 except for the uncoated area 54, and in embodiments may contact the base of the negative post 22, where the negative lead 32 is connected to the negative post.

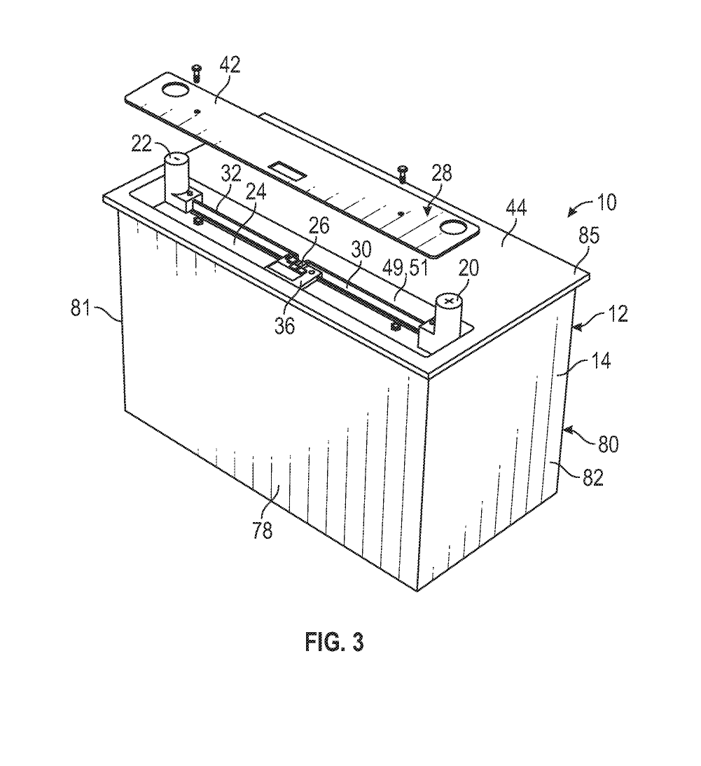

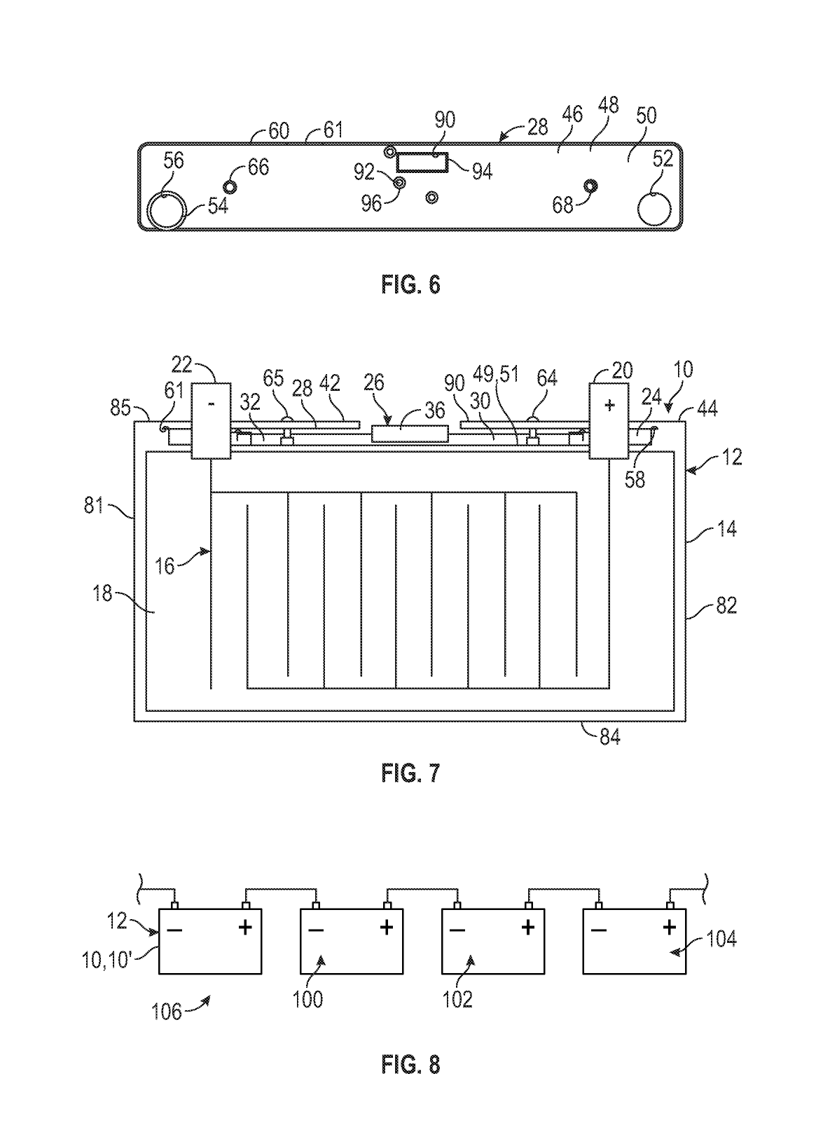

In embodiments, the recess 24, 24′ is formed in an outer surface of the battery case 14, 14′. In the embodiment of FIGS. 1 and 3, the recess includes a peripheral lip 58 that supports the cover 28. As shown in FIG. 6, the cover 28 may have a corresponding rim 60 that carries a seal 61 that extends downwardly toward the recess 24 and extends about a periphery of the plate 46. The seal 61 seals against the lip 58, in the embodiment of FIGS. 1 and 3, and against the recess bottom 62 and/or side wall 63 in the embodiment of FIGS. 2 and 4. The cover 28 is removably attached to the battery case 14, 14′, and in embodiments is attached to the top surface 44, 44′ of the battery case 14, 14′, preferably by screws 64, 65 that extend through corresponding holes 66, 68 formed in the plate 46 and thread into threaded holes 70, 72 formed in the upper surface 44, 44′ of the battery case.

As shown in FIGS. 1 and 2, the recess 24, 24′ is shaped to position the battery EBPED 26 between the positive post 20 and the negative post 22 such that positive and negative leads 30, 32, respectively, of the EBPED connected to the positive post and the negative post are minimized in length. In a particular embodiment, the EBPED body 36 is equidistant from the positive post 20 and the negative post 22. In the illustrated embodiments, the positive lead 30 is attached to the positive post 20 by a terminal screw 74, and a negative lead 32 is attached to the negative post 22 by a terminal screw 76. The battery case 14, 14′ includes front and rear opposing walls 78, 80, first and second opposing side walls 81, 82 joining the front and rear walls, a bottom wall 84 joining the front and rear walls and the first and second side walls. A top wall 85 joins the front and rear walls 78, 80 the first and second side walls 81, 82, and includes the top surface 44, 44′, which includes the recess 24, 24′ that is covered by the cover 28.

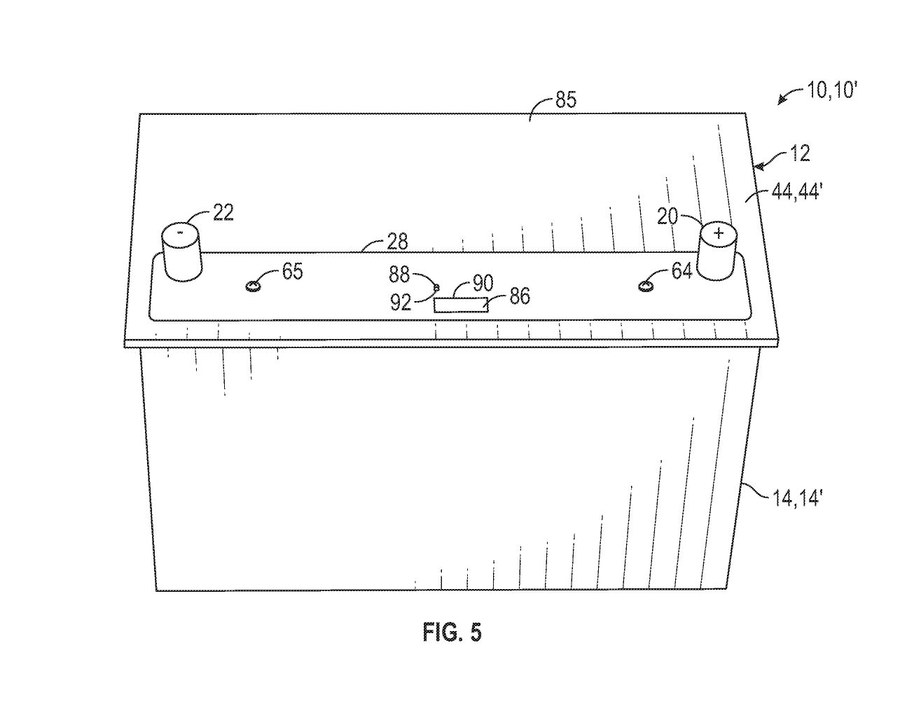

In exemplary embodiments, as best shown in FIG. 5, the battery enclosure 10, 10′ includes one or both of a visual information display 86 and an indicator light 88 for displaying information about the battery 12 and/or the associated electrical system (not shown), such as battery voltage. The cover 28 includes one or both of an information display window 90 and an indicator light window 92 (see also FIG. 4), each sized and positioned to align respectively with the visual information display 86 and the indicator light 88 to allow visual inspection of the visual information display and the indicator light when the cover 28 is attached to the battery case 14, 14′. The information display window 90 and indicator light window 92 in the cover 28 are tightly sealed against the EBPED 26, in particular the EBPED body 36, optionally including a gasket interfaces 94, 96 (see FIG. 4), to prevent infiltration of moisture, salt, dirt, and other undesirable contaminants from entering the recess 24 under the cover 28.

The disclosed battery enclosure 10, 10′ may be provided without the EBPED 26, or other electronic devices, which may be added by the purchaser or at the point of sale, or provided with the EBPED. In the latter case, the battery enclosure 10, 10′ includes a battery case 14, 14′ for enclosing at least one cell 16 in contact with in electrolyte 18; a positive post 20 and a negative post 22 connected to the at least one cell and protruding from the case; and a EBPED 26 connected to the positive post and the negative post. The case 14, 14′ has a recess 24 that receives the EBPED 26, and a cover 28 that covers the recess and the EBPED.

In embodiments, the EBPED 26 is encased in the recess 24 that keeps it separated from the electrolyte 18, which in embodiments is sulfuric acid, that otherwise would cause corrosion damage to the EBPED, but such that the chamber is part of (i.e., unitary with) the battery case 14, 14′, and in particular is integral with the top wall 86. The recess 24 can be located anywhere on the battery case, but in the illustrated embodiments is on or near the top of the battery, as shown in the Figures, to minimize the distance required to run the wires beneath the cover 28 to the battery posts 20, 22 to reduce EMI (including RFI) noise, and also to make information on the visual display 86 and the indicator light 88 easily visible. The recess 24 also can be constructed to provide a “Faraday cage” around the EBPED, further reducing RFI noise.

In embodiments, the EBPED leads 30, 32 are affixed to the battery posts 20, 22 within the recess 24 using solder, the screws 74, 76 shown in FIGS. 2, 3, and 7, ring clamps, a ring with teeth (flexible or stiff) that slides tightly over the posts in an interference fit, or any other method. The recess 24 can be manufactured as part of the battery case without a fixed top or side, to provide access for installation of the EBPED 26, attachment of the lead wires 30, 32, and positioning of the LED 88 and/or information display 92.

The EBPED cover 28 can be affixed and sealed, as desired, once the EBPED 24 is installed. The cover 28 can be permanently sealed over the recess 24 onto the top wall 85 so that the EBPED 26 cannot be removed without damaging or destroying the enclosure, such as by using a plastic weld, glue, epoxy, or otherwise making the cover non-removable, or the cover can be removable, in which case whereby it is attached such as clamping with screws, as shown in FIGS. 1, 2, 3, and 7, built in snap-connections, brackets, clasps, or by other means. In embodiments in which the cover 24 is removable from the case 14, 14′, the cover includes the seal 61 (see FIGS. 6 and 7), which can be made using a gasket, silicone, or other secure but removable sealing method.

In an embodiment in which the recess 24 and the EBPED 26 are made accessible by removing the cover 28, the cover may be removed by a mechanic or technician (using standard or special tools) in the event of a EBPED 24 failure, for replacement of the EBPED. As shown in FIG. 8, the battery 12 having the described battery enclosure 10, 10′, is connected in series to batteries 100, 102, 104 to form a battery group 106, which in embodiments may be a 4-battery group. In this arrangement, the EBPED 26 (FIGS. 1 and 2) performs performance enhancement of the batteries in the group 106, which in embodiments includes desulfation. In exemplary embodiments, none, some, or all of batteries 100, 102, 104 may have the disclosed battery enclosure 10, 10′ with enclosed EBPED(s) 26. In still other embodiments, none, some, or all of batteries 100, 102, 104 may have the battery enclosure 24, but may contain electronic devices, such as battery monitoring devices and/or electrical system devices, other than, or in addition to EBPED 24.

A method of making the disclosed battery enclosure 10, 10′ includes enclosing at least one cell 16 in contact with the electrolyte 18 in the battery case 14, 14′. The positive post 20 and the negative post 22 are connected to the at least one cell to protrude from the battery case. A recess 24 is formed in the battery case 14, 14′ shaped to receive an electronic battery performance enhancement device (EBPED) 16. A cover 28, which in embodiments is molded to shape, is provided that covers the recess 24 and the EBPED 28 when received in the recess such that the EBPED, including the positive lead 30 and the negative lead 32 of the EBPED, when connected to the positive post 20 and the negative post 22, are beneath the cover. The battery case 14, 14′ of the enclosure 10, 10′ in embodiments is molded to shape, and the recess 24 is molded into the battery case.

While the forms of apparatus of the EBPED and methods of use of the EBPED disclosed herein constitute preferred embodiments of the apparatus and methods, it is to be understood that the disclosure is not limited in scope to these precise forms of apparatus and methods, and that changes may be made therein without departing from the scope of the invention.

What is claimed is:

1. A battery enclosure comprising:
a battery case for enclosing at least one cell in contact with an electrolyte;
a positive post and a negative post connected to the at least one cell and protruding from the case;
the case having a recess shaped to receive an electronic battery performance enhancement device (EBPED); and
a cover that covers the recess and the EBPED when received in the recess such that the EBPED, including positive and negative leads of the EBPED when connected to the positive post and the negative post, are beneath the cover.

2. The battery enclosure of claim 1, wherein the recess includes an EBPED compartment shaped to receive an EBPED body of the EBPED; a first channel, narrower than the EBPED compartment, extending between the EBPED compartment and the negative post that receives a negative lead from the EBPED; and a second channel, narrower than the EBPED compartment, extending between the EBPED compartment and the positive post that receives a positive lead from the EBPED.

3. The battery enclosure of claim 2, wherein the EBPED compartment, the first channel, and the second channel are covered by the cover.

4. The battery enclosure of claim 1, wherein an outer surface of the cover is flush with an outer surface of the battery case when attached to the battery case.

5. The battery enclosure of claim 1, wherein the cover includes shielding that reduces one or both of electromagnetic interference and radio frequency interference from operation of the EBPED when the EBPED is received in the recess.

6. The battery enclosure of claim 5, wherein the cover includes a plate, and the electromagnetic shielding is a layer of conductive shielding on the plate and the recess.

7. The battery enclosure of claim 6, wherein the layer of conductive shielding is a spray coating or plating of conductive material on an underside surface of the plate facing the recess, and on a surface of the recess, and optionally the layer of conductive shielding is grounded to the negative post of the battery.

8. The battery enclosure of claim 1, wherein the recess is formed in an outer surface of the battery case.

9. The battery enclosure of claim 8, wherein the recess includes a peripheral lip that supports the cover.

10. The battery enclosure of claim 1, wherein the cover is removably attached to the battery case.

11. The battery enclosure of claim 10, wherein the cover is attached to a top surface of the battery case, preferably by screws.

12. The battery enclosure of claim 10, wherein the cover includes holes that receive the positive post and the negative post therethrough.

13. The battery enclosure of claim 1, wherein the recess is shaped to position the EBPED between the positive post and the negative post, such that positive and negative leads of the EBPED connected to the positive post and the negative post are minimized in length.

14. The battery enclosure of claim 1, further comprising an EBPED positioned in the recess beneath the cover; the EBPED including an EBPED body, a positive lead attached to the positive post, and a negative lead attached to the negative post, such that performance enhancement, which optionally includes desulfation, of at least one cell, is effected by operation of the EBPED.

15. The battery enclosure of claim 14, wherein the positive lead and the negative lead are beneath the cover.

16. The battery enclosure of claim 14, wherein the EBPED body is equidistant from the positive post and the negative post.

17. The battery enclosure of claim 1, wherein the battery case includes front and rear opposing walls, first and second opposing side walls joining the front and rear walls, a bottom wall joining the front and rear walls and the first and second side walls, and a top wall joining the front and rear walls and the first and second side walls; the top wall including the recess and the cover.

18. The battery enclosure of claim 1, wherein the EBPED includes one or both of a visual information display and an indicator light, and the cover includes one or both of an information display window and an indicator light window, each sized and positioned to align respectively with the visual information display and the indicator light to allow visual inspection of the visual information display and the indicator light when the cover is attached to the battery case.

19. A battery enclosure comprising:
a battery case for enclosing at least one cell immersed in electrolyte;
a positive post and a negative post connected to the at least one cell and protruding from the case;
informational and/or diagnostic equipment selected from a battery voltage sensor, a battery charge level sensor, a battery state of health sensor, an alternator state of health sensor, a low-voltage disconnect, a remote sensor for voltage monitoring and control, and a battery charge booster for jump starts;
the case having a recess that receives the informational and/or diagnostic equipment; and
a cover that covers the recess and the informational and/or diagnostic equipment.

20. A method of making a battery enclosure, the method comprising:
enclosing at least one cell in contact with an electrolyte in a battery case;
mounting a positive post and a negative post connected to the at least one cell to protrude from the battery case;
forming a recess in the case shaped to receive an electronic battery performance enhancement device (EBPED); and
providing a cover that covers the recess and the EBPED when received in the recess such that the EBPED, including positive and negative leads of the EBPED when connected to the positive post and the negative post, are beneath the cover.
